(19) United States
(12) Patent Application Publication
(10) Pub. No.: US 2009/0067690 A1
(43) Pub. Date: Mar. 12, 2009

(54) Fingerprint Sensor with Bump Packaging

(75) Inventor: Jean-Francois Mainguet, Grenoble (FR)

Correspondence Address: FISH & RICHARDSON P.C., PO BOX 1022, MINNEAPOLIS, MN, 55440-1022, US

(73) Assignee: ATMEL SWITZERLAND, Fribourg (CH)

(21) Appl. No.: 11/853,301

(22) Filed: Sep. 11, 2007

(51) Int. Cl. G06K 9/00

(52) U.S. Cl. 382/124

(57) ABSTRACT

A biometric sensing device includes a sensor manufacture for sensing a biometric stimulus. The sensor manufacture includes a transitional segment between a side wall and an upper plateau. The transitional segment reduces deformation of a swiped finger, providing a tolerance in the positioning of the sensor device relative to a swiping platform.

### BACKGROUND

This disclosure relates to sensing devices.

Sensing devices can include sensor manufactures that can transduce one form of energy into another, e.g., charged coupled devices, piezoelectric materials, or pyroelectric materials. Such sensing devices can include basic control circuitry (e.g., e.g., amplifiers, analog-to-digital converters, input/output circuitry, and the like) on device (e.g., on-chip). The data output by the sensing device can be processed by a processing device in communication with the sensing device.

Sensing devices for use in biometrics provide data output for use in human identification. For example, data output by a biometric sensing device can be provided to a processing device which processes the data received from the sensor device to reconstruct a fingerprint image and attempt to authenticate or identify the fingerprint. A fingerprint sensor can be proportioned to receive an entire fingerprint of a finger, or be of smaller proportions where an image of a fingerprint is generated by receiving successive partial images of a fingerprint as a finger is swiped across the sensor.

To avoid distortion and errors in fingerprint data captured from a finger swiped across a sensor, it is advantageous to position a fingerprint sensor such that its sensing surface is flush with an adjacent platform. Improper mounting positions which are lower or higher than a flush mounting position can result in distortion of fingerprint data caused by inadequate contact of a finger with the sensor positioned lower than a surrounding platform and deformation of a finger as it is swiped across a raised ridge of a sensor that is positioned higher that a surrounding platform.

FIG. 1 is a perspective view of an example fingerprint swiping assembly 100. The assembly has a lateral axis ‘X’, a longitudinal axis ‘Y’, and a vertical axis ‘Z’. A prior art sensor manufacture 102 is shown situated proximate to a swiping platform 108. The swiping platform 108 can have a slot 103 configured to receive the sensor manufacture 102. The sensor manufacture 102 is situated in relation to the swiping platform 108 and its slot 103 so that a finger swiped in a direction ‘D’ slides across a surface 106 of the swiping platform 108, onto a surface 104 of the sensor manufacture 102, and back onto the surface 106 of the swiping platform. For acquisition of fingerprint data, the sensor manufacture 102 is positioned so that the surface of a finger swiped in direction ‘D’ will transition smoothly from sliding across the swiping platform surface 106 to sliding contact with the sensor manufacture surface 104 and again onto the swiping platform surface 106.

FIG. 2 is a plan view of example fingerprint swiping assembly 100. Section line A-A defines a plane perpendicular to the plan view and which penetrates through the prior art sensor manufacture 102 and the swiping platform 108.

FIG. 3A shows a cross section of a fingerprint swiping assembly having a properly positioned prior art sensor manufacture 102. The cross section is taken along section line A-A of FIG. 2. The prior art sensor manufacture 102 is shown attached to a mounting board 303. Mounting board 303 can be, for example, a circuit board. The prior art sensor manufacture 102 has a profile with substantially right angles at the intersection of the upper surface 104 and side walls 306 and 308. The right angles of this sensor manufacture profile constrain the positioning of the sensor manufacture surface 104 with respect to the swiping platform surface 312 to a narrow window of tolerance. The sensor manufacture 102 is shown in FIG. 3A as being positioned with its surface 104 lying in substantially the same plane as the surface 312 of the swiping platform. This alignment enables a finger to be swiped smoothly across the assembly and a fingerprint of the finger to be acquired. Finger contour 310 represents an example finger swiped across the assembly in the direction ‘D’. The finger is shown making contact with the sensing device enabling a proper fingerprint scan. Due to the smooth transition, however, little or no tactile feedback regarding contact with the sensing device is received by the swiped finger.

FIG. 3B shows a cross section of a fingerprint swiping assembly having a prior art sensor manufacture 102 positioned high with respect to the swiping platform. The high positioning of the sensor manufacture surface 104 with respect to the swiping platform surface 312 creates a ridge in the composite swiping surface (the combined surfaces of the swiping platform and the sensor manufacture). The example finger contour 314 shows that the skin of the finger is distorted by the ridge such that the skin does not contact a portion ‘P’ of the sensor manufacture surface 104. The distortion can in some cases prevent or degrade the proper acquisition of a fingerprint by the sensing device. For example, depending on the sampling rate of the device and the speed at which a finger is swiped across it, the distortion can create gaps in a captured fingerprint.

FIG. 3C shows a cross section of a fingerprint swiping assembly having a prior art sensor manufacture 102 positioned low with respect to the swiping platform. The low positioning of the sensor manufacture surface 104 with respect to the surface of the swiping platform 312 prevents the example finger contour 316 from contacting the surface of the sensor manufacture 104. No contact is made between the finger and the sensor manufacture shown. A slightly higher position of the sensor manufacture 102 could enable some contact between the finger at a narrow area near the center of the sensor manufacture surface 104, but still result in improper fingerprint captures.

FIGS. 3A-3C show prior art sensor manufactures having a sensing surface 104 at a right angle to sides 306 and 308. The right angled profile requires tight tolerances in the positioning of the prior art sensor manufacture 102 with respect to a swiping platform. Producing, for example, a product having an integrated sensor manufacture requires that the sensor manufacture be mounted in a position enabling a finger to swipe across the surface of the swiping platform (which can be, for example, an outer casing of the product) and the sensor manufacture so that a fingerprint can be captured. As shown in FIG. 3B, mounting the sensor manufacture too high can distort the skin of a finger swiped across the assembly. Mounting the sensor manufacture too low can prevent adequate contact with a surface of the sensor manufacture, or any contact at all.

### SUMMARY

Disclosed herein is a fingerprint sensor manufacture with bump packaging.

In an implementation, a cross section of a fingerprint sensor manufacture is defined by a first transitional segment and a plateau.

In implementations, the cross section can further be defined by a first wall segment, a second transitional segment and a second wall segment. The surface of the fingerprint sensor manufacture can be configured to sense a fingerprint as a finger is swiped across a surface of the fingerprint sensor manufacture. The fingerprint sensor manufacture can be configured to sense the fingerprint capacitively, and/or thermally, or by some other transduction process. In some implementations, the fingerprint sensor manufacture includes a pyroelectric material. A fingerprint sensor device including the fingerprint sensor manufacture can include electrical terminals for providing electrical signals corresponding to a swiped fingerprint.

In an implementation, a transitional segment defines a constant radius arc. Alternatively, a transitional segment can define an increasing radius arc or a decreasing radius arc.

A fingerprint sensor manufacture can be positioned relative to a swiping platform to permit a finger to be swiped from the swiping platform across the fingerprint sensor manufacture. In implementations the fingerprint sensor manufacture is positioned relative to the swiping platform such that the plateau is within a distance of a surface of the swiping platform that is less than or equal to a radius of an arc of a transitional segment.

Optional advantages and other advantages can be separately realized by the fingerprint sensor manufacture. The configuration of the fingerprint sensor manufacture provides a window of tolerance in positioning the device relative to a swiping platform within which successful fingerprint captures are possible. Such example advantages, however, need not be realized in particular implementations.

### BRIEF DESCRIPTION OF THE DRAWINGS

FIG. 1 is a perspective view of an example fingerprint swiping assembly.

FIG. 2 is a plan view of an example fingerprint swiping assembly.

FIG. 3A shows a cross section of a fingerprint swiping assembly having a properly positioned prior art sensor manufacture.

FIG. 3B shows a cross section of a fingerprint swiping assembly having a prior art sensor manufacture positioned high with respect to the swiping platform.

FIG. 3C shows a cross section of a fingerprint swiping assembly having a prior art sensor manufacture positioned low with respect to the swiping platform.

FIG. 4 is a block diagram of an example sensing device.

FIGS. 5 and 6 are block diagrams of example data regions defined within a biometric transducer of an example sensing device.

FIG. 7A is a perspective view of an example fingerprint sensing device having a sensor manufacture with bump packaging.

FIG. 7B shows a cross section of an example fingerprint sensing device having a biometric transducer and a sensor manufacture with bump packaging.

FIG. 8A shows a cross section of an example fingerprint swiping assembly having a sensor manufacture with bump packaging positioned with a sensor plateau higher than the surface of the swiping platform by a distance ‘a’.

FIG. 8B shows a cross section of an example fingerprint swiping assembly having a sensor manufacture with bump packaging positioned with a sensor plateau 715 higher than the surface of the swiping platform by a distance ‘b’.

FIG. 8C shows a cross section of an example fingerprint swiping assembly having a sensor manufacture with bump packaging positioned with a sensor surface level with the surface of the swiping platform.

FIG. 9 shows a partial cross section of an example sensor manufacture with bump packaging having a transitional segment with a constant radius.

FIG. 10 shows a partial cross section of an example sensor manufacture with bump packaging having a transitional segment with a decreasing radius.

FIG. 11 shows a partial cross section of an example sensor manufacture with bump packaging having a transitional segment with an increasing radius.

FIG. 12A shows a cross section of an example fingerprint sensing device having a biometric transducer and a sensor manufacture with bump packaging.

FIG. 12B shows a cross section of an example fingerprint swiping assembly having a sensor manufacture with bump packaging positioned with a sensor plateau higher than the surface of a swiping platform.

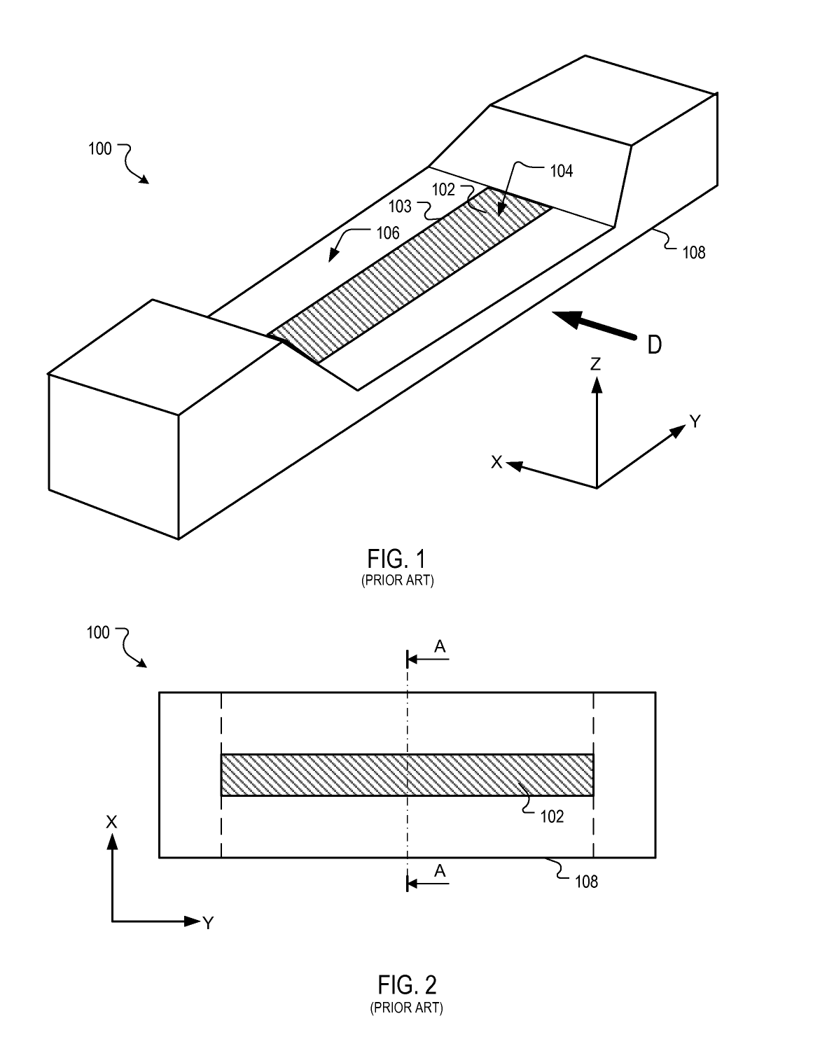

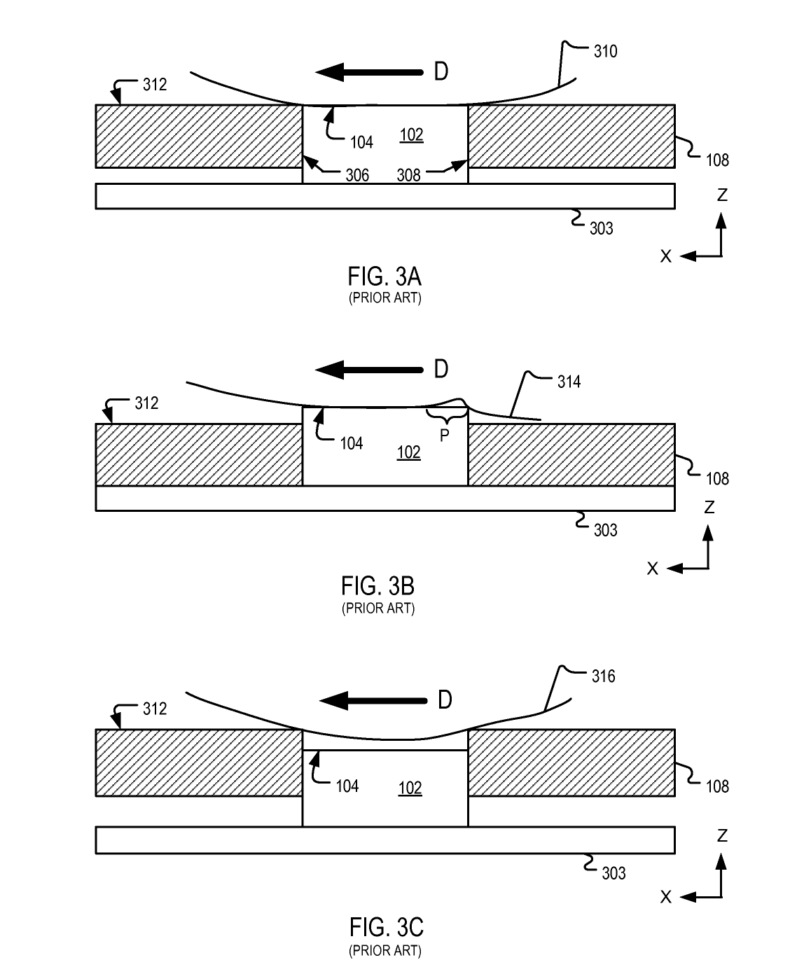

### DETAILED DESCRIPTION

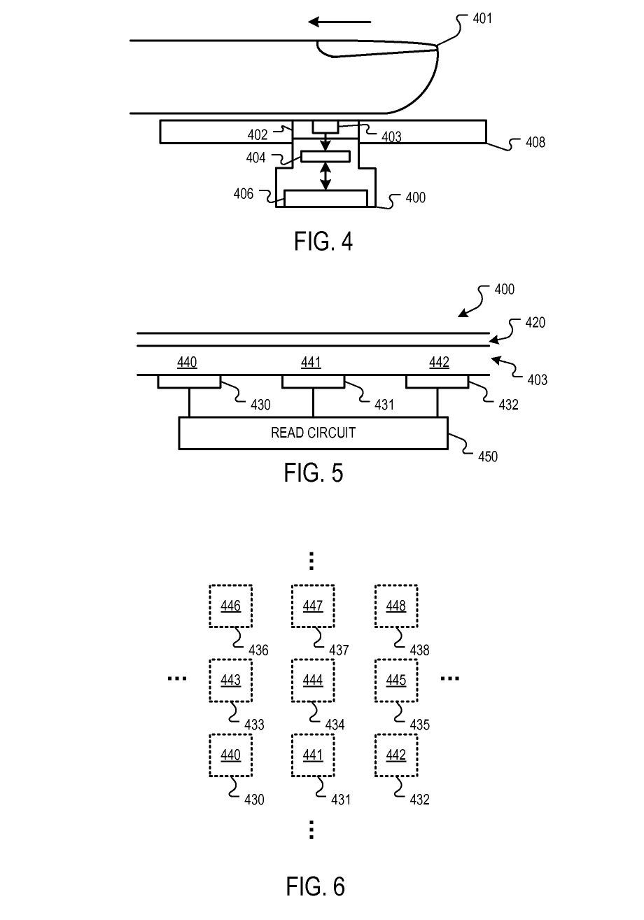

FIG. 4 is a block diagram of an example sensing device 400. The example sensing device 400 can be a biometric sensing device configured to sense a biometric stimulus, such as the swiping of a finger 401 to read a corresponding fingerprint, for example. The sensing device 400 can implement a different type of sensor, however.

The sensing device 400 can include a sensor manufacture 402 including a biometric transducer 403. An output of the biometric transducer 403 can be coupled to a processing circuit 404 and an input/output circuit 406. As the finger 401 is swiped across the sensor manufacture the biometric transducer 403 generates electrical signals based on a characteristic of the fingerprint on the finger 401. The source material of the biometric transducer 403 can, for example, comprise a layer of polyvinylidene fluoride (PVDF), polyvinylidene fluoride, trifluoroethylene (PVDF-TrFE), polyvinylidene cyanide—vinyl acetate (PVDCN-VAc), or some other transducing material that can produce an electric charge in response to a physical stimulus, such as a biometric stimulus.

The electric signals output by the biometric transducer 403 are processed by the processing circuit 404 and output through the input/output circuit 406 as biometric data to a processing device, such as a microprocessor executing filtering and recognition algorithms. The example sensing device 400 can generate multiple instances per second of, for example, biometric data, with each instance corresponding to a partial image of a fingerprint. The multiple instances of biometric data can be processed by the processing device to detect overlapping data and generate a complete image of the fingerprint of the finger 401. The sensing device 400 is situated proximate to a swiping platform 408 that provides support for a finger as it is swiped toward and over the sensing device.

FIGS. 5 and 6 are block diagrams of example data regions defined within a biometric transducer 403 of an example sensing device 400. The data regions can provide an electrical signal corresponding to an external stimulus such as the swiping of a finger 401 across a surface of the sensor manufacture 402. The biometric transducer 403 can, for example, comprise a layer of pyroelectric material fabricated between an upper electrode 420 and a matrix array of lower electrodes as depicted by electrodes 430-438 in FIGS. 5 and 6. Corresponding regions 440-448 are defined by each lower electrode 430-438 and the upper electrode 420. In one implementation, the upper electrode 420 can comprises a single electrode fabricated atop the biometric transducer 403. In another implementation, the upper electrode 420 can comprises multiple electrodes fabricated atop the biometric transducer 403, e.g., row electrodes, or column electrodes, or a plurality of electrodes corresponding to the electrodes 430-438.

As shown in FIG. 6, the lower electrodes 430-438 can, for example, be arranged in rows and columns. The number of rows and columns can vary according to the particular implementation of the sensor device 400. For example, the biometric transducer 403 can comprise a relatively few number or rows and multiple columns and be configured to provide overlapping sections of biometric data during a finger swipe. Alternatively, the biometric transducer 403 can comprise multiple rows and columns and be configured to provide a single instance of biometric data for an entire fingerprint. In one implementation, the biometric transducer 403 can be approximately 1.2 centimeters in width and approximately 0.4 millimeters in length, and can comprise 8 rows of electrodes, with each row comprising 232 electrodes. Other configurations can also be used. A processing circuit 404, such as, for example, a read circuit 450, can be connected to the lower electrodes 430-438.

A sensor manufacture having “bump” packaging provides a greater tolerance window for positioning a sensor manufacture with respect to a swiping platform than sensor manufactures having rectangular profiles. A sensor manufacture with bump packaging can provide tactile feedback to a user.

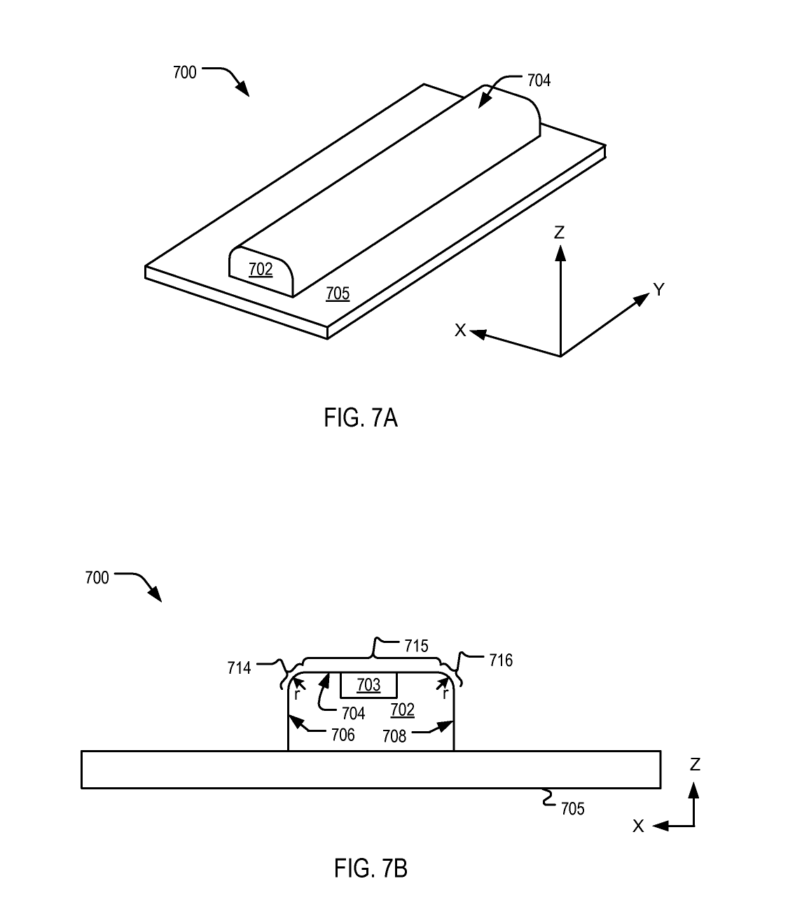

FIG. 7A is a perspective view of an example fingerprint sensing device 700 having a sensor manufacture 702 with bump packaging. The fingerprint sensing device has a lateral axis ‘X’, a longitudinal axis ‘Y’, and a vertical axis ‘Z’. The sensor manufacture 702 is attached to a circuit board 705.

FIG. 7B shows a cross section of an example fingerprint sensing device 700 having a biometric transducer 703 and a sensor manufacture 702 with bump packaging. The side walls 706 and 708 lie in parallel planes that are, for example, perpendicular to a plane of a plateau 715 of the sensor manufacture 702. The profile of transitional segment 714 between the wall 706 and a plateau 715 is an arc having a radius ‘r’. The profile of transitional segment 716 between the wall 708 and the plateau 715 is an arc having a radius ‘r’. The transitional segments 714 and 716 provide a greater window of tolerance for positioning the sensor manufacture 702 with respect to a swiping platform than that provided by the prior art sensor manufacture 102.

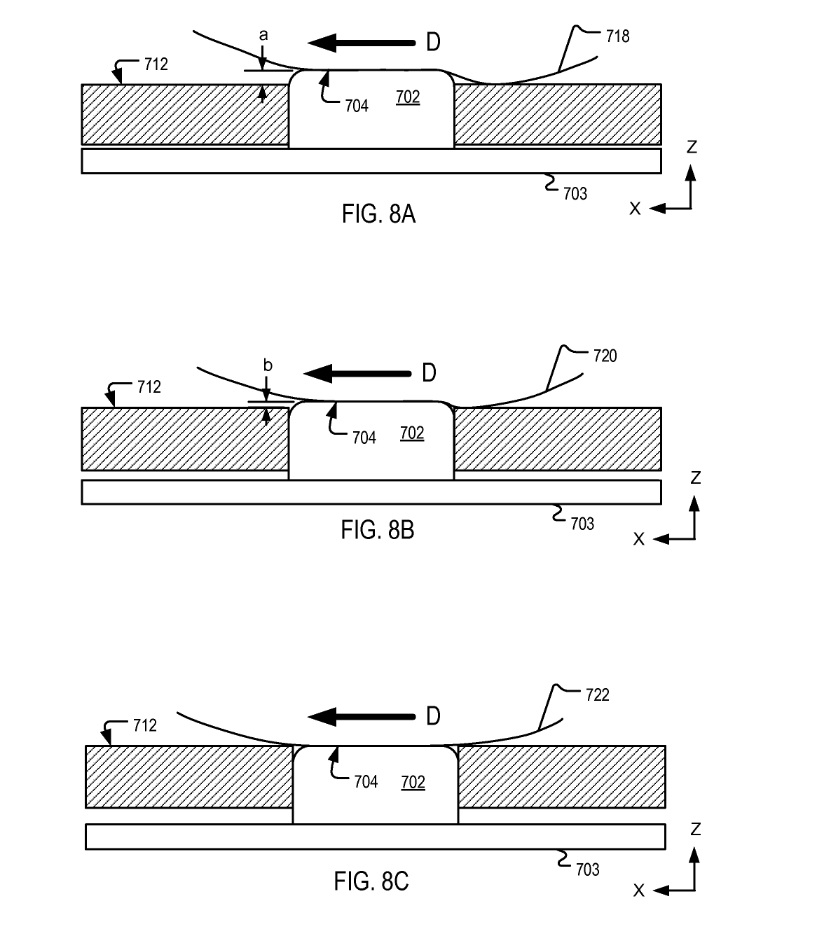

FIG. 8A shows a cross section of an example fingerprint swiping assembly having a sensor manufacture 702 with bump packaging positioned with a sensor plateau higher than the surface of the swiping platform by a distance ‘a’. In the example shown, the distance ‘a’ is equal to the radius ‘r’ of the arc. The example finger contour 718 shows that deformation of a finger swiped across the assembly is reduced by the rounded corners of the transitional segments 714 and 716.

FIG. 8B shows a cross section of an example fingerprint swiping assembly having a sensor manufacture 702 with bump packaging positioned with a sensor plateau higher than the surface of the swiping platform by a distance ‘b’. The distance “b” is such that the transitional segments 714 and 716 extend below the surface 712. The example finger contour 720 shows that proper contact of the finger with the surface 704 of the fingerprint sensor for capturing a fingerprint is maintained with this positioning of the device with respect to the swiping platform.

FIG. 8C shows a cross section of an example fingerprint swiping assembly having a sensor manufacture 702 with bump packaging positioned with a sensor surface level with the surface of the swiping platform. The example finger contour 722 shows that proper contact of the finger with the surface 704 of the fingerprint sensor for capturing a fingerprint is maintained with this positioning of the device with respect to the swiping platform.

Where a fingerprint sensor manufacture is positioned so that a plateau of a the fingerprint sensor manufacture is elevated above a surface of a swiping platform, the transitional segments reduce deformation of a finger swiped across a sensor/swiping platform assembly. The reduction in deformation enables proper fingerprint captures to be made with the fingerprint sensor manufacture positioned higher with respect to a swiping platform by at least a radius ‘r’ of the transitional segments. Proper fingerprint captures are possible at higher sensor manufacture positions with a sensor manufacture 702 than are possible with the prior art sensor manufacture 102.

Sensor manufacture 702 provides a greater tolerance window of useful potential mounting positions with respect to a swiping platform. The higher tolerance provides benefits in the production of devices incorporating the sensor manufacture 702. A production process can, for example, be designed to mount a fingerprint sensing device having a sensor manufacture 702 so that a plateau 715 of the sensor manufacture is a distance of one-half of the radius ‘r’ of transitional segments 714 and 716 of the sensor manufacture above a surface 712 of a swiping platform. If, through some irregularities in device components or assembly process, the sensing device is mounted with the plateau higher or lower than the designed for elevation, a fingerprint of a finger swiped across the assembly can still be captured. The sensing device can be mounted at least a distance of one half of ‘r’ lower than the designed for height and at least one half of ‘r’ higher than the designed for height and the resulting assembly can properly capture fingerprints.

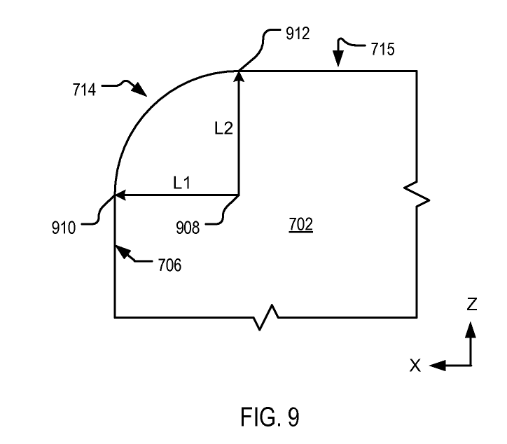

FIG. 9 shows a partial cross section of an example sensor manufacture 702 with bump packaging having a transitional segment 714 with a constant radius. Point 910 marks the end of the side wall 706 and the beginning of the transitional segment 714. The transitional segment turns from the side wall on an arc having a center at point 908 and a radius of ‘L1’. The transitional segment continues along an arc having a constant radius measured from the point 908. The transitional segment ends at point 912 where the radius of the arc is ‘L2 ’ and the plateau 715 begins. For the example sensor manufacture 702, ‘L1 ’ equals ‘L2’. The sensor manufacture 702 can have a corresponding transitional area between the plateau 715 and a second side wall (not shown). The sensor manufacture 702 can provide a window of tolerance for positioning the plateau 715 relative to a swiping platform of at least a distance equal to L2 along the vertical axis ‘Z’.

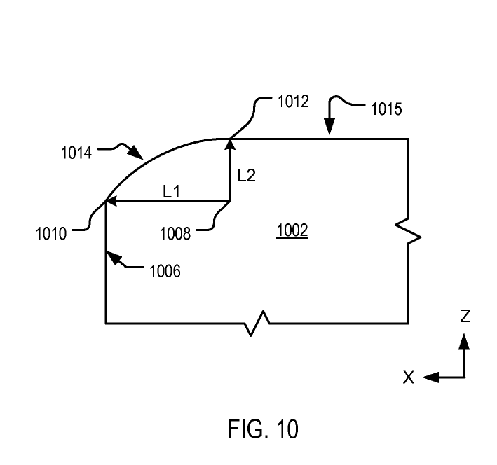

FIG. 10 shows a partial cross section of an example sensor manufacture 1102 with bump packaging having a transitional segment 1014 with a decreasing radius. Point 1010 marks the end of the side wall 1006 and the beginning of the transitional segment 1014. The transitional segment turns from the side wall on an arc having a center at point 1008 and an initial radius of ‘L1’. The transitional segment continues along an arc having a decreasing radius measured from the point 1008. The transitional segment ends at point 1012 where the radius of the arc is ‘L2 ’ and the plateau 1015 begins. For the example sensor manufacture 1002, ‘L1 ’ is greater than ‘L2’. The sensor manufacture 1002 can have a corresponding transitional area between the plateau 1015 and a second side wall (not shown). The sensor manufacture 1002 can provide a window of tolerance for positioning the plateau 1015 relative to a swiping platform of at least a distance equal to L2 along the vertical axis ‘Z’.

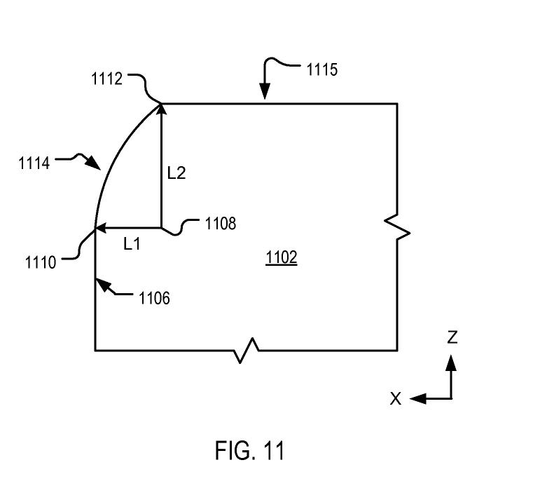

FIG. 11 shows a partial cross section of an example sensor manufacture 1102 with bump packaging having a transitional segment 1114 with an increasing radius. Point 1110 marks the end of the side wall 1106 and the beginning of the transitional segment 1114. The transitional segment turns from the side wall on an arc having a center at point 1108 and an initial radius of ‘L1’. The transitional segment continues along an arc having an increasing radius measured from the point 1108. The transitional segment ends at point 1112 where the radius of the arc is ‘L2 ’ and the plateau 1115 begins. For the example sensor manufacture 1102, ‘L1 ’ is less than ‘L2’. The sensor manufacture 1102 can have a corresponding transitional area between the plateau 1115 and a second side wall. The sensor manufacture 1102 can provide a window of tolerance for positioning the plateau 1115 relative to a swiping platform of at least a distance equal to L2 along the vertical axis ‘Z’.

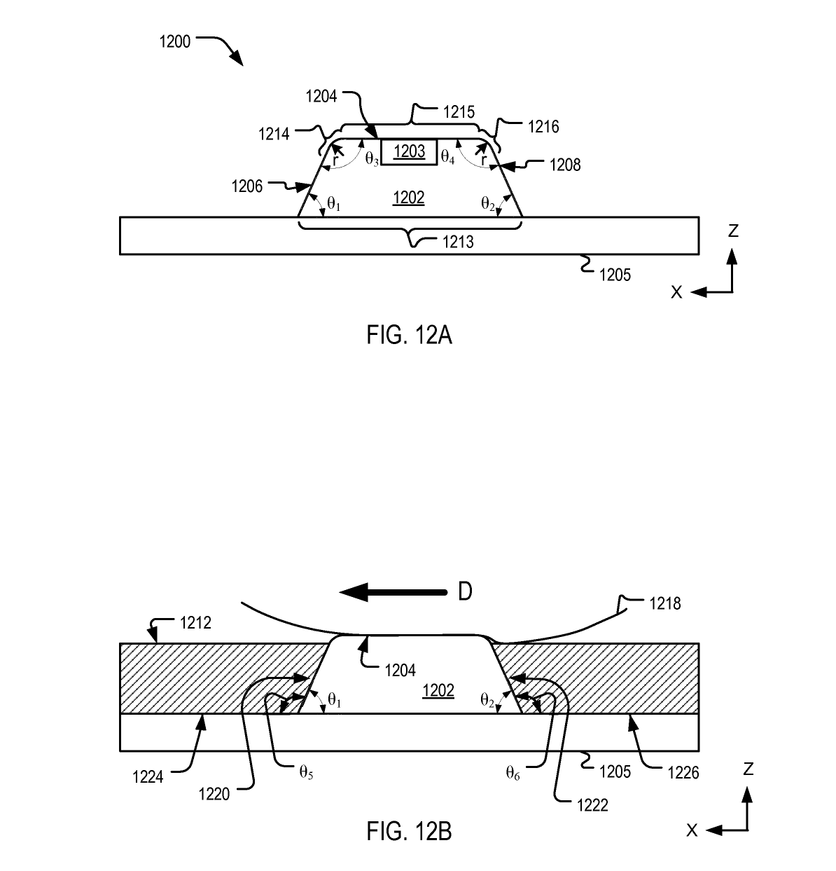

FIG. 12A shows a cross section of an example fingerprint sensing device 1200 having a biometric transducer 1203 and a sensor manufacture 1202 with bump packaging. The sensor manufacture 1202 is attached to a circuit board 1205. The base segment 1213 of the sensor manufacture 1202 has a length greater than that of the plateau 1215. The side walls 1206 and 1208 extend from the base segment 1213 at an angle θ₁ and θ₂, respectively. The side wall 1206 extends from the transitional segment 1214 at an angle θ₃ with respect to the plateau, and the side wall 1208 extends from the transitional segment 1216 at an angle θ₄. In an implementation, θ₁ and θ₂ are acute angles and θ₃ and θ₄ are obtuse angles. In an implementation, angle θ₃ supplements angle θ₁, and angle θ₄ supplements angle θ₂. That is, angle θ₁+θ₃=θ₂+θ₄=180 degrees. In an implementation, θ₁=θ₂, and θ₃=θ₄.

The profile of transitional segment 1214 between the wall 1206 and the plateau 1215 can have an arc of radius ‘r’, and the profile of transitional segment 1216 between the wall 1208 and the plateau 1215 can have an arc having a radius ‘r’. The transitional segments 1214 and 1216 provide a greater window of tolerance for positioning the sensor manufacture 1202 with respect to a swiping platform than that provided by the sensor manufacture 102.

FIG. 12B shows a cross section of an example fingerprint swiping assembly having a sensor manufacture 1202 with bump packaging positioned with a sensor plateau higher than the surface of a swiping platform 1212. The example finger contour 1218 shows that deformation of a finger swiped across the assembly is reduced by the rounded corners of the transitional segments 1214 and 1216.

Sidewalls 1220 and 1222 of the swiping platform 1212 are slanted from vertical. In an implementation, the walls are slanted at an angle (relative to bottom segments 1224 and 1226, respectively) that is compatible with the slanting of the side walls of the sensor manufacture 1202. For example, the side walls 1220 and 1222 can be slanted such that the angle θ₅ is the supplement of θ₁ and θ₆ is the supplement of θ₂. That is, θ₁+θ₅=θ₂+θ₆=180 degrees. In an implementation, θ₃=θ₄=θ₅=θ₆. The supplemental relationship of the side walls 1220 and 1222 to the side walls 1206 and 1208, respectively, can aid in mounting and/or aligning the sensor manufacture 1202 with respect to the swiping platform. The resulting alignment between the sensor manufacture 1202 with respect to the swiping platform can reduce the accumulation of dirt and other unwanted debris between the sensor manufacture and the swiping platform over time.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A fingerprint sensor manufacture, comprising:
a first transitional segment;
a plateau extending from the first transitional segment; and
a sensing surface configured to sense a fingerprint, the sensing surface disposed on the plateau.

2. The fingerprint sensor manufacture of claim 1, further comprising:
a first wall segment connected to the first transitional segment;
a second transitional segment connected to the plateau; and
a second wall segment connected to the second transitional segment.

3. The fingerprint sensor manufacture of claim 2, wherein:
the first side wall extends from the first transitional segment at an obtuse angle relative to the plateau.

4. The fingerprint sensor manufacture of claim 2, further comprising:
a base segment extending from the first wall segment to the second wall segment, wherein:
the base segment has a length greater than a length of the plateau;
an intersection of the first side wall and the base segment defines an acute angle; and
an intersection of the second side wall and the base segment defines an acute angle.

5. The fingerprint sensor manufacture of claim 1, wherein:
the fingerprint sensor manufacture comprises a pyroelectric material.

6. The fingerprint sensor manufacture of claim 1, wherein:
the fingerprint sensor manufacture is configured to capacitively sense a fingerprint.

7. The fingerprint sensor manufacture of claim 1, wherein:
the fingerprint sensor manufacture is configured to thermally sense a fingerprint.

8. The fingerprint sensor manufacture of claim 1, wherein:
the first transitional segment defines a constant radius arc.

9. The fingerprint sensor manufacture of claim 1, wherein:
the first transitional segment defines an increasing radius arc.

10. The fingerprint sensor manufacture of claim 1, wherein:
the first transitional segment defines a decreasing radius arc.

11. An apparatus comprising:
a fingerprint sensing device having a fingerprint sensor manufacture defined by a side wall, a transitional segment, a plateau, and a sensing surface disposed on the plateau configured to sense a fingerprint; and
a swiping platform, the fingerprint sensing device being positioned relative to the swiping platform to permit a finger to be swiped from the swiping platform across the fingerprint sensor manufacture.

12. The apparatus of claim 11, wherein:
the transitional segment defines an arc having a constant radius.

13. The apparatus of claim 11, wherein:
the fingerprint sensing device is positioned relative to the swiping platform such that the plateau is within a distance of a surface of the swiping platform along a vertical axis, the distance being less than or equal to the radius.

14. The apparatus of claim 11, wherein:
the transitional segment defines an arc having a first radius at a point of beginning at the sidewall and a second radius at a point of termination at the plateau.

15. The apparatus of claim 14, wherein:
the fingerprint sensing device is positioned relative to the swiping platform such that the plateau is within a distance of a surface of the swiping platform along a vertical axis, the distance being less than or equal to the second radius.

16. The apparatus of claim 11, wherein:
the side wall of the fingerprint sensing device extends from the first transitional segment at a first obtuse angle relative to the plateau; and
a first wall of the swiping platform defines a second obtuse angle relative to a bottom segment of the swiping platform.

17. The apparatus of claim 16, wherein:
the first obtuse angle is substantially equal to the second obtuse angle.

18. An apparatus, comprising:
fingerprint sensing device means defined by a side wall, a transitional segment, and a plateau; and
a swiping platform for mounting the fingerprint sensing device means.

19. The apparatus of claim 18, wherein:
the transitional segment defines a constant radius arc.

20. The apparatus of claim 18, wherein:
the transitional segment defines an increasing radius arc.

21. The apparatus of claim 18, wherein:
the transitional segment defines a decreasing radius arc.
